(19) United States
(12) Patent Application Publication
(10) Pub. No.: US 2019/0394711 A1
(43) Pub. Date: Dec. 26, 2019

(54) METHOD FOR RECEIVING DATA RELATED TO NON-3GPP VIA 3GPP ACCESS IN WIRELESS COMMUNICATION SYSTEM, AND APPARATUS FOR SAME

(71) Applicant: LG ELECTRONICS INC., Seoul (KR)

(72) Inventor: Laeyoung KIM, Seoul (KR)

(73) Assignee: LG ELECTRONICS INC., Seoul (KR)

(21) Appl. No.: 16/065,071

(22) PCT Filed: Feb. 22, 2018
(86) PCT No.: PCT/KR2018/002203

§ 371 Date: Jun. 21, 2018

Related U.S. Application Data
(60) Provisional application No. 62/461,794, filed on Feb. 22, 2017.
(60) Provisional application No. 62/463,696, filed on Feb. 26, 2017.
(60) Provisional application No. 62/475,887, filed on Mar. 24, 2017.

(51) Int. Cl. H04W 48/16; H04W 76/25; H04W 68/00; H04W 80/10; H04W 8/08; H04W 60/00; H04W 76/27

(52) U.S. Cl. CPC H04W 48/16; H04W 76/25; H04W 68/005; H04W 84/042; H04W 8/08; H04W 60/005; H04W 76/27; H04W 80/10

(57) ABSTRACT

In one embodiment of the present invention, a method for receiving, by a UE (User Equipment), receiving data related with non-3GPP through 3GPP access in a wireless communication system comprises the steps of receiving NAS notification message or a paging message; and transmitting a service request in response to the NAS notification message or the paging message, wherein the service request includes PDU session information related with non-3GPP access, and the UE receives, through 3GPP access, downlink data related with non-3GPP through 3GPP access through a PDU session, which related with the PDU session information and is activated in 3GPP access.

### TECHNICAL FIELD

The following description relates to a wireless communication system, and more particularly, to a method for receiving data related with non-3GPP through 3GPP access in each network node and a device therefor.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.) among them. For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi-Carrier Frequency Division Multiple Access (MC-FDMA) system.

### DISCLOSURE

### Technical Problem

An object of the present invention is to provide connection management for non-3GPP access, particularly a method for receiving data related with non-3GPP through 3GPP access in each network node and a device therefor.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

In one embodiment of the present invention, a method for receiving, by a UE (User Equipment), receiving data related with non-3GPP through 3GPP access in a wireless communication system comprises the steps of receiving NAS notification message or a paging message; and transmitting a service request in response to the NAS notification message or the paging message, wherein the service request includes PDU session information related with non-3GPP access, wherein the UE receives downlink data related with non-3GPP via a PDU session which related with the PDU session information and is activated in 3GPP access, and wherein the UE receives the downlink data through 3GPP access.

In one embodiment of the present invention, a UE device for receiving data through non-3GPP access or 3GPP access in a wireless communication system comprises a transceiver; and a processor, wherein the processor receives NAS notification message or a paging message, and transmits a service request in response to the NAS notification message or the paging message, wherein the service request includes PDU session information related with non-3GPP access, wherein the UE receives downlink data related with non-3GPP via a PDU session which related with the PDU session information and is activated in 3GPP access, and wherein the UE receives the downlink data through 3GPP access.

The NAS notification message or the paging message may be for downlink data related with non-3GPP access.

The UE may be connected in 3GPP access and IDLE in non-3GPP access.

The 3GPP access and the non-3GPP access may belong to the same PLMN.

The UE may be registered with both of the 3GPP access and the non-3GPP access.

The NAS notification message may include access associated information and may be transmitted through the 3GPP access.

The UE may be IDLE in both of the 3GPP access and the non-3GPP access.

The paging message may include access associated information, and may be transmitted through the 3GPP access.

The 3GPP access and the non-3GPP access belong to the same PLMN.

The UE may be registered with both of the 3GPP access and the non-3GPP access.

If the UE is registered with the non-3GPP access only and is IDLE state in the non-3GPP access, information indicating that the UE is unreachable may be transmitted from AMF (Access and Mobility Management Function) to SMF.

The information indicating that UE is unreachable may be delivered from the SMF to UPF.

The downlink data related with the non-3GPP access may be deleted by the UPF after the information indicating that the UE is unreachable is delivered to the UPF.

The AMF of the UE may store information indicating that PDU session is for the non-3GPP access or the 3GPP access.

### Advantageous Effects

According to the present invention, connection management may efficiently be performed for non-3GPP access.

It will be appreciated by persons skilled in the art that the effects that can be achieved through the present invention are not limited to what has been particularly described hereinabove and other advantages of the present invention will be more clearly understood from the following detailed description.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 is a diagram illustrating a brief structure of an evolved packet system (EPS) that includes an evolved packet core (EPC).

FIG. 2 is an exemplary diagram illustrating an architecture of a general E-UTRAN and a general EPC.

FIG. 3 is an exemplary diagram illustrating a structure of a radio interface protocol on a control plane.

FIG. 4 is an exemplary diagram illustrating a structure of a radio interface protocol on a user plane.

FIG. 5 is a flow chart illustrating a random access procedure.

FIG. 6 is a diagram illustrating a connection procedure in a radio resource control (RRC) layer.

FIG. 7 is a diagram illustrating a 5G system.

FIG. 8 is a diagram illustrating various support methods of non-3GPP access.

FIG. 9 illustrates a registration procedure through an unreliable non-3GPP access.

FIG. 10 illustrates a PDU session establishment procedure through an unreliable non-3GPP access.

FIG. 11 illustrates a deregistration procedure through an unreliable non-3GPP access.

FIG. 12 is a diagram illustrating the embodiment of the present invention.

FIG. 13 is a diagram illustrating a configuration of a node device according to the embodiment of the present invention.

### BEST MODE FOR CARRYING OUT THE INVENTION

The embodiments below are combinations of components and features of the present invention in a prescribed form. Each component or feature may be considered as selective unless explicitly mentioned as otherwise. Each component or feature may be executed in a form that is not combined with other components and features. Further, some components and/or features may be combined to configure an embodiment of the present invention. The order of operations described in the embodiments of the present invention may be changed. Some components or features of an embodiment may be included in another embodiment or may be substituted with a corresponding component or feature of the present invention.

Specific terms used in the description below are provided to help an understanding of the present invention, and the use of such specific terms may be changed to another form within the scope of the technical concept of the present invention.

In some cases, in order to avoid obscurity of the concept of the present invention, a known structure and apparatus may be omitted, or a block diagram centering on core functions of each structure or apparatus may be used. Moreover, the same reference numerals are used for the same components throughout the present specification.

The embodiments of the present invention may be supported by standard documents disclosed with respect to at least one of IEEE (Institute of Electrical and Electronics Engineers) 802 group system, 3GPP system, 3GPP LTE & LTE-A system and 3GPP2 system. Namely, the steps or portions having not been described in order to clarify the technical concept of the present invention in the embodiments of the present invention may be supported by the above documents. Furthermore, all terms disclosed in the present document may be described according to the above standard documents.

The technology below may be used for various wireless communication systems. For clarity, the description below centers on 3GPP LTE and 3GPP LTE-A, by which the technical idea of the present invention is non-limited.

Terms used in the present document are defined as follows.
UMTS (Universal Mobile Telecommunications System): a GSM (Global System for Mobile Communication) based third generation mobile communication technology developed by the 3GPP.
EPS (Evolved Packet System): a network system that includes an EPC (Evolved Packet Core) which is an IP (Internet Protocol) based packet switched core network and an access network such as LTE and UTRAN. This system is the network of an evolved version of the UMTS.
NodeB: a base station of GERAN/UTRAN. This base station is installed outdoor and its coverage has a scale of a macro cell.
eNodeB: a base station of LTE. This base station is installed outdoor and its coverage has a scale of a macro cell.
UE (User Equipment): the UE may be referred to as terminal, ME (Mobile Equipment), MS (Mobile Station), etc. Also, the UE may be a portable device such as a notebook computer, a cellular phone, a PDA (Personal Digital Assistant), a smart phone, and a multimedia device. Alternatively, the UE may be a non-portable device such as a PC (Personal Computer) and a vehicle mounted device. The term “UE”, as used in relation to MTC, can refer to an MTC device.
HNB (Home NodeB): a base station of UMTS network. This base station is installed indoor and its coverage has a scale of a micro cell.
HeNB (Home eNodeB): a base station of an EPS network. This base station is installed indoor and its coverage has a scale of a micro cell.
MME (Mobility Management Entity): a network node of an EPS network, which performs mobility management (MM) and session management (SM).
PDN-GW (Packet Data Network-Gateway)/PGW: a network node of an EPS network, which performs UE IP address allocation, packet screening and filtering, charging data collection, etc.
SGW (Serving Gateway): a network node of an EPS network, which performs mobility anchor, packet routing, idle-mode packet buffering, and triggering of an MME's UE paging.
NAS (Non-Access Stratum): an upper stratum of a control plane between a UE and an MME. This is a functional layer for transmitting and receiving a signaling and traffic message between a UE and a core network in an LTE/UMTS protocol stack, and supports mobility of a UE, and supports a session management procedure of establishing and maintaining IP connection between a UE and a PDN GW.
PDN (Packet Data Network): a network in which a server supporting a specific service (e.g., a Multimedia Messaging Service (MMS) server, a Wireless Application Protocol (WAP) server, etc.) is located.
PDN connection: a logical connection between a UE and a PDN, represented as one IP address (one IPv4 address and/or one IPv6 prefix).
RAN (Radio Access Network): a unit including a Node B, an eNode B, and a Radio Network Controller (RNC) for controlling the Node B and the eNode B in a 3GPP network, which is present between UEs and provides a connection to a core network.
HLR (Home Location Register)/HSS (Home Subscriber Server): a database having subscriber information in a 3GPP network. The HSS can perform functions such as configuration storage, identity management, and user state storage.
PLMN (Public Land Mobile Network): a network configured for the purpose of providing mobile communication services to individuals. This network can be configured per operator.
Proximity Services (or ProSe Service or Proximity-based Service): a service that enables discovery between physically proximate devices, and mutual direct communication/communication through a base station/communication through the third party. At this time, user plane data are exchanged through a direct data path without through a 3GPP core network (for example, EPC).

EPC (Evolved Packet Core)

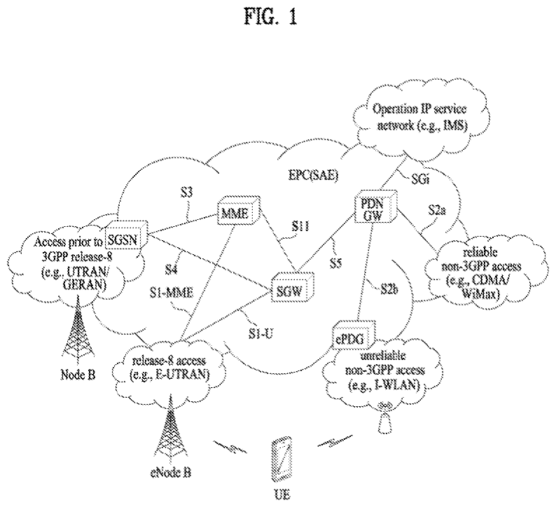

FIG. 1 is a schematic diagram showing the structure of an evolved packet system (EPS) including an evolved packet core (EPC).

The EPC is a core element of system architecture evolution (SAE) for improving performance of 3GPP technology. SAE corresponds to a research project for determining a network structure supporting mobility between various types of networks. For example, SAE aims to provide an optimized packet-based system for supporting various radio access technologies and providing an enhanced data transmission capability.

Specifically, the EPC is a core network of an IP mobile communication system for 3GPP LTE and can support real-time and non-real-time packet-based services. In conventional mobile communication systems (i.e. second-generation or third-generation mobile communication systems), functions of a core network are implemented through a circuit-switched (CS) sub-domain for voice and a packet-switched (PS) sub-domain for data. However, in a 3GPP LTE system which is evolved from the third generation communication system, CS and PS sub-domains are unified into one IP domain. That is, In 3GPP LTE, connection of terminals having IP capability can be established through an IP-based business station (e.g., an eNodeB (evolved Node B)), EPC, and an application domain (e.g., IMS). That is, the EPC is an essential structure for end-to-end IP services.

The EPC may include various components. FIG. 1 shows some of the components, namely, a serving gateway (SGW), a packet data network gateway (PDN GW), a mobility management entity (MME), a serving GPRS (general packet radio service) supporting node (SGSN) and an enhanced packet data gateway (ePDG).

The SGW operates as a boundary point between a radio access network (RAN) and a core network and maintains a data path between an eNodeB and the PDN GW. When. When a terminal moves over an area served by an eNodeB, the SGW functions as a local mobility anchor point. That is, packets. That is, packets may be routed through the SGW for mobility in an evolved UMTS terrestrial radio access network (E-UTRAN) defined after 3GPP release-8. In addition, the SGW may serve as an anchor point for mobility of another 3GPP network (a RAN defined before 3GPP release-8, e.g., UTRAN or GERAN (global system for mobile communication (GSM)/enhanced data rates for global evolution (EDGE) radio access network).

The PDN GW corresponds to a termination point of a data interface for a packet data network. The PDN GW may support policy enforcement features, packet filtering and charging support. In addition, the PDN GW may serve as an anchor point for mobility management with a 3GPP network and a non-3GPP network (e.g., an unreliable network such as an interworking wireless local area network (I-WLAN) and a reliable network such as a code division multiple access (CDMA) or WiMax network).

Although the SGW and the PDN GW are configured as separate gateways in the example of the network structure of FIG. 1, the two gateways may be implemented according to a single gateway configuration option.

The MME performs signaling and control functions for supporting access of a UE for network connection, network resource allocation, tracking, paging, roaming and handover. The MME controls control plane functions associated with subscriber and session management. The MME manages numerous eNodeBs and signaling for selection of a conventional gateway for handover to other 2G/3G networks. In addition, the MME performs security procedures, terminal-to-network session handling, idle terminal location management, etc.

The SGSN handles all packet data such as mobility management and authentication of a user for other 3GPP networks (e.g., a GPRS network).

The ePDG serves as a security node for a non-3GPP network (e.g., an I-WLAN, a Wi-Fi hotspot, etc.).

As described above with reference to FIG. 1, a terminal having IP capabilities may access an IP service network (e.g., an IMS) provided by an operator via various elements in the EPC not only based on 3GPP access but also based on non-3GPP access.

Additionally, FIG. 1 shows various reference points (e.g. S1-U, S1-MME, etc.). In 3GPP, a conceptual link connecting two functions of different functional entities of an E-UTRAN and an EPC is defined as a reference point. Table 1 is a list of the reference points shown in FIG. 1. Various reference points may be present in addition to the reference points in Table 1 according to network structures.

TABLE 1

| Reference | |
|---|---|
| point | Description |
| S1-MME | Reference point for the control plane protocol between |
| | E-UTRAN and MME |
| S1-U | Reference point between E-UTRAN and Serving GW for the |
| | per bearer user plane tunneling and inter eNodeB path |
| | switching during handover |
| S3 | It enables user and bearer information exchange for |
| | inter 3GPP access network mobility in idle and/or |
| | active state. This reference point can be used |
| | intra-PLMN or inter-PLMN (e.g. in the case of |
| | Inter-PLMN HO). |
| S4 | It provides related control and mobility support between |
| | GPRS Core and the 3GPP Anchor function of Serving GW. In |
| | addition, if Direct Tunnel is not established, it provides |
| | the user plane tunneling. |
| S5 | It provides user plane tunneling and tunnel management |
| | between Serving GW and PDN GW. It is used for Serving |
| | GW relocation due to UE mobility and if the Serving GW |
| | needs to connect to a non-collocated PDN GW for the |
| | required PDN connectivity. |
| S11 | Reference point between an MME and an SGW |
| SGi | It is the reference point between the PDN GW and the |
| | packet data network. Packet data network may be an |
| | operator external public or private packet data |
| | network or an intra operator packet data network, |
| | e.g. for provision of IMS services. This reference |
| | point corresponds to Gi for 3GPP accesses. |

Among the reference points shown in FIG. 1, S2a and S2b correspond to non-3GPP interfaces. S2a is a reference point which provides reliable non-3GPP access and related control and mobility support between PDN GWs to a user plane. S2b is a reference point which provides related control and mobility support between the ePDG and the PDN GW to the user plane.

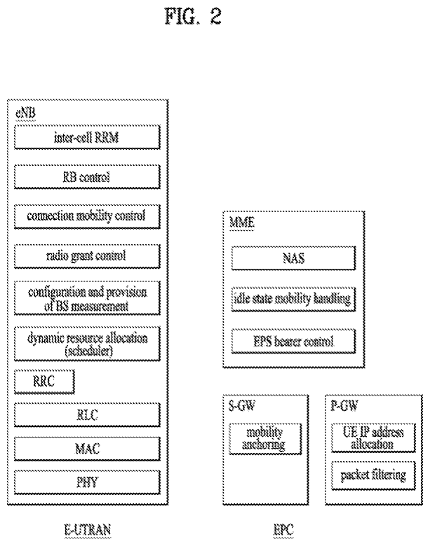

FIG. 2 is a diagram exemplarily illustrating architectures of a typical E-UTRAN and EPC.

As shown in the figure, while radio resource control (RRC) connection is activated, an eNodeB may perform routing to a gateway, scheduling transmission of a paging message, scheduling and transmission of a broadcast channel (BCH), dynamic allocation of resources to a UE on uplink and downlink, configuration and provision of eNodeB measurement, radio bearer control, radio admission control, and connection mobility control. In the EPC, paging generation, LTE_IDLE state management, ciphering of the user plane, SAE bearer control, and ciphering and integrity protection of NAS signaling.

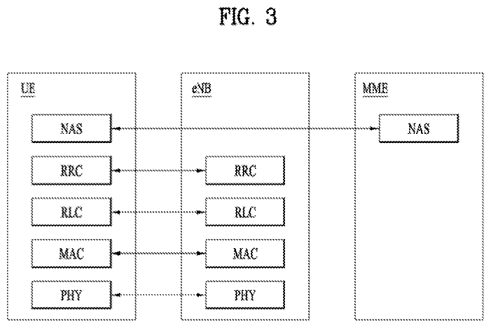

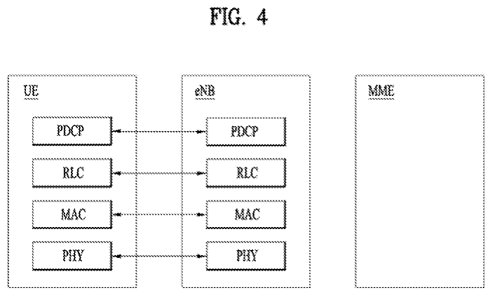

FIG. 3 is a diagram exemplarily illustrating the structure of a radio interface protocol in a control plane between a UE and a base station, and FIG. 4 is a diagram exemplarily illustrating the structure of a radio interface protocol in a user plane between the UE and the base station.

The radio interface protocol is based on the 3GPP wireless access network standard. The radio interface protocol horizontally includes a physical layer, a data link layer, and a networking layer. The radio interface protocol is divided into a user plane for transmission of data information and a control plane for delivering control signaling which are arranged vertically.

The protocol layers may be classified into a first layer (L1), a second layer (L2), and a third layer (L3) based on the three sublayers of the open system interconnection (OSI) model that is well known in the communication system.

Hereinafter, description will be given of a radio protocol in the control plane shown in FIG. 3 and a radio protocol in the user plane shown in FIG. 4.

The physical layer, which is the first layer, provides an information transfer service using a physical channel. The physical channel layer is connected to a medium access control (MAC) layer, which is a higher layer of the physical layer, through a transport channel Data is transferred between the physical layer and the MAC layer through the transport channel Transfer of data between different physical layers, i.e., a physical layer of a transmitter and a physical layer of a receiver is performed through the physical channel.

The physical channel consists of a plurality of subframes in the time domain and a plurality of subcarriers in the frequency domain. One subframe consists of a plurality of symbols in the time domain and a plurality of subcarriers. One subframe consists of a plurality of resource blocks. One resource block consists of a plurality of symbols and a plurality of subcarriers. A Transmission Time Interval (TTI), a unit time for data transmission, is 1 ms, which corresponds to one subframe.

According to 3GPP LTE, the physical channels present in the physical layers of the transmitter and the receiver may be divided into data channels corresponding to Physical Downlink Shared Channel (PDSCH) and Physical Uplink Shared Channel (PUSCH) and control channels corresponding to Physical Downlink Control Channel (PDCCH), Physical Control Format Indicator Channel (PCFICH), Physical Hybrid-ARQ Indicator Channel (PHICH) and Physical Uplink Control Channel (PUCCH).

The second layer includes various layers.

First, the MAC layer in the second layer serves to map various logical channels to various transport channels and also serves to map various logical channels to one transport channel. The MAC layer is connected with an RLC layer, which is a higher layer, through a logical channel. The logical channel is broadly divided into a control channel for transmission of information of the control plane and a traffic channel for transmission of information of the user plane according to the types of transmitted information.

The radio link control (RLC) layer in the second layer serves to segment and concatenate data received from a higher layer to adjust the size of data such that the size is suitable for a lower layer to transmit the data in a radio interval.

The Packet Data Convergence Protocol (PDCP) layer in the second layer performs a header compression function of reducing the size of an IP packet header which has a relatively large size and contains unnecessary control information, in order to efficiently transmit an IP packet such as an IPv4 or IPv6 packet in a radio interval having a narrow bandwidth. In addition, in LTE, the PDCP layer also performs a security function, which consists of ciphering for preventing a third party from monitoring data and integrity protection for preventing data manipulation by a third party.

The Radio Resource Control (RRC) layer, which is located at the uppermost part of the third layer, is defined only in the control plane, and serves to configure radio bearers (RBs) and control a logical channel, a transport channel, and a physical channel in relation to reconfiguration and release operations. The RB represents a service provided by the second layer to ensure data transfer between a UE and the E-UTRAN.

If an RRC connection is established between the RRC layer of the UE and the RRC layer of a wireless network, the UE is in the RRC Connected mode. Otherwise, the UE is in the RRC Idle mode.

Hereinafter, description will be given of the RRC state of the UE and an RRC connection method. The RRC state refers to a state in which the RRC of the UE is or is not logically connected with the RRC of the E-UTRAN. The RRC state of the UE having logical connection with the RRC of the E-UTRAN is referred to as an RRC_CONNECTED state. The RRC state of the UE which does not have logical connection with the RRC of the E-UTRAN is referred to as an RRC_IDLE state. A UE in the RRC_CONNECTED state has RRC connection, and thus the E-UTRAN may recognize presence of the UE in a cell unit. Accordingly, the UE may be efficiently controlled. On the other hand, the E-UTRAN cannot recognize presence of a UE which is in the RRC_IDLE state. The UE in the RRC_IDLE state is managed by a core network in a tracking area (TA) which is an area unit larger than the cell. That is, for the UE in the RRC_IDLE state, only presence or absence of the UE is recognized in an area unit larger than the cell. In order for the UE in the RRC_IDLE state to be provided with a usual mobile communication service such as a voice service and a data service, the UE should transition to the RRC_CONNECTED state. A TA is distinguished from another TA by a tracking area identity (TAI) thereof. A UE may configure the TAI through a tracking area code (TAC), which is information broadcast from a cell.

When the user initially turns on the UE, the UE searches for a proper cell first. Then, the UE establishes RRC connection in the cell and registers information thereabout in the core network. Thereafter, the UE stays in the RRC_IDLE state. When necessary, the UE staying in the RRC_IDLE state selects a cell (again) and checks system information or paging information. This operation is called camping on a cell. Only when the UE staying in the RRC_IDLE state needs to establish RRC connection, does the UE establish RRC connection with the RRC layer of the E-UTRAN through the RRC connection procedure and transition to the RRC_CONNECTED state. The UE staying in the RRC_IDLE state needs to establish RRC connection in many cases. For example, the cases may include an attempt of a user to make a phone call, an attempt to transmit data, or transmission of a response message after reception of a paging message from the E-UTRAN.

The non-access stratum (NAS) layer positioned over the RRC layer performs functions such as session management and mobility management.

Hereinafter, the NAS layer shown in FIG. 3 will be described in detail.

The eSM (evolved Session Management) belonging to the NAS layer performs functions such as default bearer management and dedicated bearer management to control a UE to use a PS service from a network. The UE is assigned a default bearer resource by a specific packet data network (PDN) when the UE initially accesses the PDN. In this case, the network allocates an available IP to the UE to allow the UE to use a data service. The network also allocates QoS of a default bearer to the UE. LTE supports two kinds of bearers. One bearer is a bearer having characteristics of guaranteed bit rate (GBR) QoS for guaranteeing a specific bandwidth for transmission and reception of data, and the other bearer is a non-GBR bearer which has characteristics of best effort QoS without guaranteeing a bandwidth. The default bearer is assigned to a non-GBR bearer. The dedicated bearer may be assigned a bearer having QoS characteristics of GBR or non-GBR.

A bearer allocated to the UE by the network is referred to as an evolved packet service (EPS) bearer. When the EPS bearer is allocated to the UE, the network assigns one ID. This ID is called an EPS bearer ID. One EPS bearer has QoS characteristics of a maximum bit rate (MBR) and/or a guaranteed bit rate (GBR).

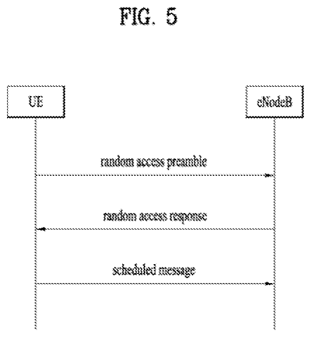

FIG. 5 is a flowchart illustrating a random access procedure in 3GPP LTE.

The random access procedure is used for a UE to obtain UL synchronization with an eNB or to be assigned a UL radio resource.

The UE receives a root index and a physical random access channel (PRACH) configuration index from an eNodeB. Each cell has 64 candidate random access preambles defined by a Zadoff-Chu (ZC) sequence. The root index is a logical index used for the UE to generate 64 candidate random access preambles.

Transmission of a random access preamble is limited to a specific time and frequency resources for each cell. The PRACH configuration index indicates a specific subframe and preamble format in which transmission of the random access preamble is possible.

The UE transmits a randomly selected random access preamble to the eNodeB. The UE selects a random access preamble from among 64 candidate random access preambles and the UE selects a subframe corresponding to the PRACH configuration index. The UE transmits the selected random access preamble in the selected subframe.

Upon receiving the random access preamble, the eNodeB sends a random access response (RAR) to the UE. The RAR is detected in two steps. First, the UE detects a PDCCH masked with a random access (RA)-RNTI. The UE receives an RAR in a MAC (medium access control) PDU (protocol data unit) on a PDSCH indicated by the detected PDCCH.

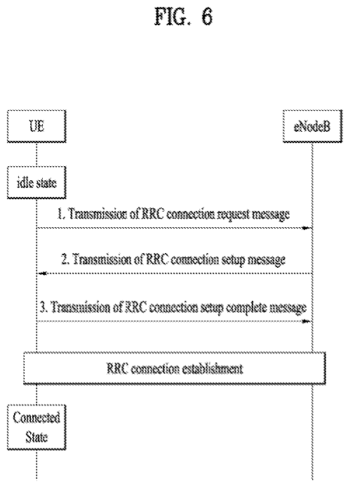

FIG. 6 illustrates a connection procedure in a radio resource control (RRC) layer.

As shown in FIG. 6, the RRC state is set according to whether or not RRC connection is established. An RRC state indicates whether or not an entity of the RRC layer of a UE has logical connection with an entity of the RRC layer of an eNodeB. An RRC state in which the entity of the RRC layer of the UE is logically connected with the entity of the RRC layer of the eNodeB is called an RRC connected state. An RRC state in which the entity of the RRC layer of the UE is not logically connected with the entity of the RRC layer of the eNodeB is called an RRC idle state.

A UE in the Connected state has RRC connection, and thus the E-UTRAN may recognize presence of the UE in a cell unit. Accordingly, the UE may be efficiently controlled. On the other hand, the E-UTRAN cannot recognize presence of a UE which is in the idle state. The UE in the idle state is managed by the core network in a tracking area unit which is an area unit larger than the cell. The tracking area is a unit of a set of cells. That is, for the UE which is in the idle state, only presence or absence of the UE is recognized in a larger area unit. In order for the UE in the idle state to be provided with a usual mobile communication service such as a voice service and a data service, the UE should transition to the connected state.

When the user initially turns on the UE, the UE searches for a proper cell first, and then stays in the idle state. Only when the UE staying in the idle state needs to establish RRC connection, the UE establishes RRC connection with the RRC layer of the eNodeB through the RRC connection procedure and then performs transition to the RRC connected state.

The UE staying in the idle state needs to establish RRC connection in many cases. For example, the cases may include an attempt of a user to make a phone call, an attempt to transmit data, or transmission of a response message after reception of a paging message from the E-UTRAN.

In order for the UE in the idle state to establish RRC connection with the eNodeB, the RRC connection procedure needs to be performed as described above. The RRC connection procedure is broadly divided into transmission of an RRC connection request message from the UE to the eNodeB, transmission of an RRC connection setup message from the eNodeB to the UE, and transmission of an RRC connection setup complete message from the UE to eNodeB, which are described in detail below with reference to FIG. 6.

1) When the UE in the idle state desires to establish RRC connection for reasons such as an attempt to make a call, a data transmission attempt, or a response of the eNodeB to paging, the UE transmits an RRC connection request message to the eNodeB first.

2) Upon receiving the RRC connection request message from the UE, the ENB accepts the RRC connection request of the UE when the radio resources are sufficient, and then transmits an RRC connection setup message, which is a response message, to the UE.

3) Upon receiving the RRC connection setup message, the UE transmits an RRC connection setup complete message to the eNodeB. Only when the UE successfully transmits the RRC connection setup message, does the UE establish RRC connection with the eNode B and transition to the RRC connected mode.

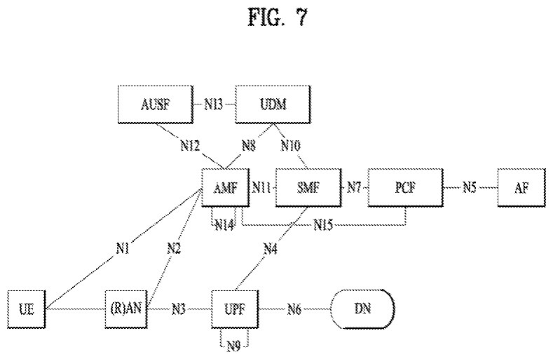

In the legacy EPC, MME is categorized into AMF (Core Access and Mobility Management Function) and SMF (session Management Function) in a Next Generation system (or 5G core network (CN)). Therefore, NAS interaction and MM (Mobility Management) with the UE are performed by the AMF, and SM (Session Management) is performed by the SMF. Also, the SMF manages a UPF (User plane Function) which is a gateway having a user-plane function, that is, for routing user traffic. In this case, a control-plane portion of S-GW and P-GW in the legacy EPC may be managed by the SMF, and a user-plane portion may be managed by the UPF. For routing of user traffic, one or more UPFs may exist between RAN and DN (Data Network). That is, the legacy EPC may be configured in 5G as illustrated in FIG. 7. Also, as a concept corresponding to PDN connection in the legacy EPS, a PDU (Protocol Data Unit) session is defined in the 5G system. The PDU session refers to association between a UE, which provides PDU connectivity services of Ethernet type or unstructured type as well as IP type, and a DN. In addition, a UDM (Unified Data Management) performs a function corresponding to HSS of EPC, and PCF (Policy Control Function) performs a function corresponding to PCRF of the EPC. To satisfy requirements of the 5G system, the functions may be provided in an enlarged type. Details of the 5G system architecture, each function and each interface follows TS 23.501.

Each network node of the 5G system will be described in more detail. The AMF includes the following functions to support a non-3GPP access network. First of all, the first function is to support N2 interface with N3IWF (Non-3GPP InterWorking Function). Some information (for example, 3GPP cell identification) and procedure (for example, handover related procedure) defined through 3GPP access may not be applied through this interface, and non-3GPP access specific information which is not applied to 3GPP access may be applied. The AMF may support NAS signaling to the UE through N3IWF. Some procedure supported by NAS signaling through 3GPP access cannot be applied unreliable non-3GPP (for example, paging) access. The AMF may support authentication of UE connected through N3IWF. The AMF manages mobility and authentication/security context state of the UE connected through non-3GPP access or 3GPP and non-3GPP accesses.

In case of unreliable non-3GPP access, the N3IWF may perform the following functions. First of all, the N3IWF supports IPsec tunnel configuration with the UE. The N3IWF terminates IKEv2/IPsec protocol through NWu, authenticates the UE and relay information required to give an access power for a 5G core network through N2. Secondly, the N3IWF is an end between N2 and N3 interfaces for a 5G core network for each of a control plane and a user plane. Also, the N3IWF relays uplink and downlink control plane NAS (N1) signaling between the UE and the AMF. Also, the N3IWF processes N2 signal in a PDU session and SMF (relayed by AMF) related to QoS, and establishes IPsec SA for supporting PDU session traffic. Also, the N3IWF relays uplink and downlink user plane packets between the UE and the UPF, wherein packet capsulation release/capsulation for IPSec and N3 tunneling, ii) QoS application corresponding to N3 packet marking considering QoS requirements related to marking received through N2, iii) N3 user plane packet markings in uplink, iv) local mobility anchor within unreliable non-3GPP access network using MOBIKE and v) AMF selection support may be included.

In addition, there are N2, N3, N4 and N6 as non-3GPP access reference points. Detailed description of the other network nodes and reference points will follow TS 23.501.

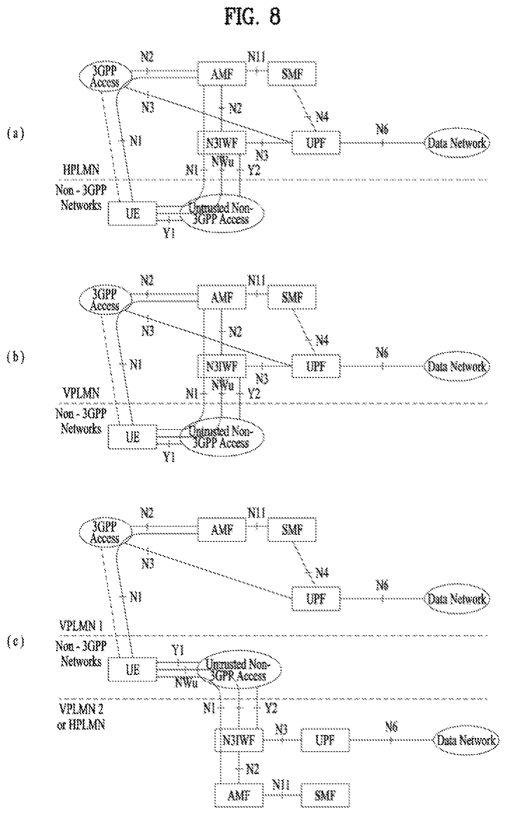

Meanwhile, the aforementioned 5G system is tasked in TS 23.501 and TS 23.502. Particularly, the 5G system (that is, next generation system) should support non-3GPP access, and thus details such as architecture for supporting non-3GPP access and network element are described in clause 4.2.7 of TS 23.501v0.2.0. A main example of non-3GPP access may include WLAN access that may include a trusted WLAN and an untrusted WLAN. FIG. 8(a) illustrates that the UE is not roamed and is connected to NG core network through 3GPP access and non-3GPP access in a home PLMN. FIG. 8(b) illustrates that the UE is roamed and is connected to NG core network through 3GPP access and non-3GPP access (this may mean N3IWF), which belong to the same visited PLMN. FIG. 8(c) illustrates that the UE is roamed and is connected to NG core network through 3GPP access which belongs to a visited PLMN#1 and at the same time connected to NG core network through non-3GPP access (this may mean N3IWF) which belongs to a visited PLMN#2. Alternatively, FIG. 8(c) illustrates that the UE is connected to NG core network through 3GPP access which belongs to a visited PLMN and at the same time connected to NG core network through non-3GPP access (this may mean N3IWF) which belongs to a home PLMN2. In this case, since the UE is connected to the NG core network through accesses which belong to their respective PLMNs different from each other, two NG core networks exist and AMF for serving the UE exists per access.

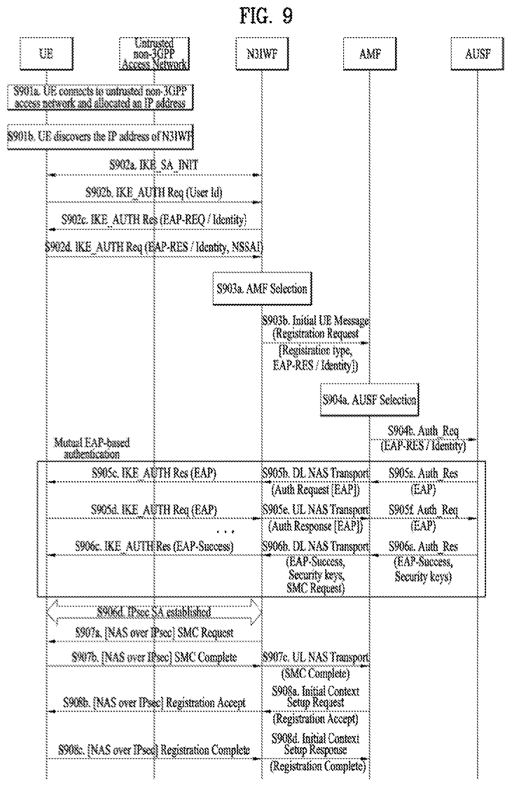

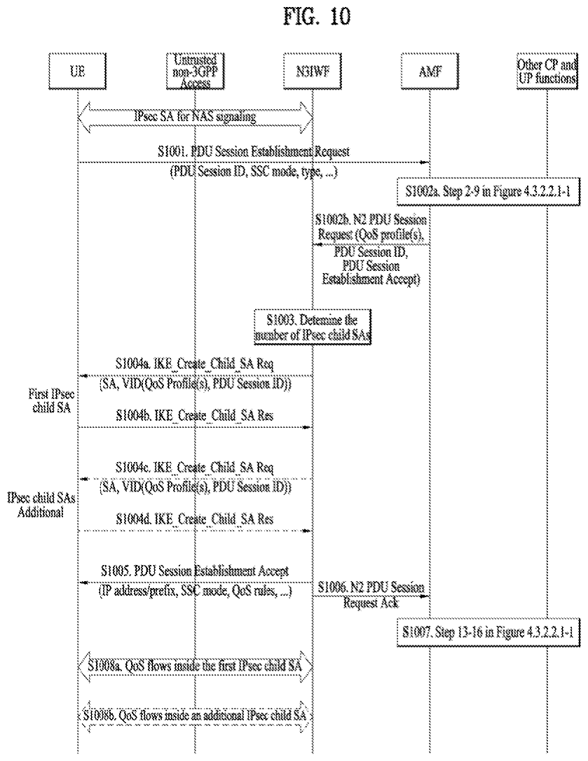

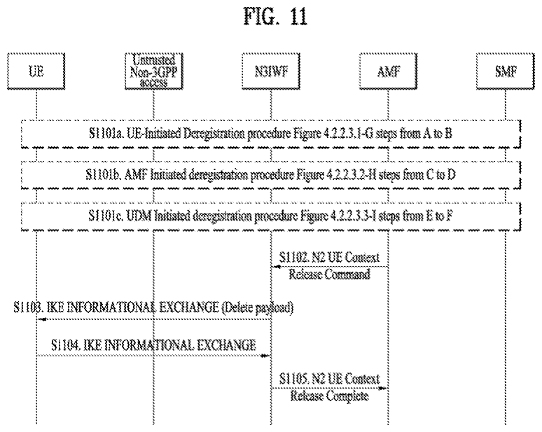

Various procedures including a registration, PDU session establishment and deregistration for supporting non-3GPP access in the 5G system are defined clause 4.12 of TS 23.502v0.1.1. A registration procedure through unreliable non-3GPP access is shown in FIG. 9, a PDU session establishment procedure through reliable non-3GPP access is shown in FIG. 10, and a deregistration procedure through unreliable non-3GPP access is shown in FIG. 11. Detailed description of FIGS. 9, 10 and 11 will be understood with reference to TS 23.502v0.1.1.

RM (Registration Management)

The UE needs to register with the network to receive services that requires registration. For registration with the selected PLMN, the UE initiates an initial Registration procedure as described in clause 4.1.1 of TS 23.502. Also the UE should initiate a periodic Registration procedure upon the expiry of the periodic Registration timer in order to maintain reachability. Also the UE may initiate a Registration procedure together with the network when moving (e.g. entering new TA) to track the UE location and reachability. The registration management procedures are applicable over both 3GPP access and non 3GPP access

5GS Registration Management state

The Registration Management (RM) states describe the Registration Management states that result from the Registration management procedures. Two RM states of RM-DEREGISTERED and RM-REGISTERED exist in RM. Transition from RM-REGISTERED to RM-DEREGISTERED may occur regardless of the CM state. However, as the transition from RM-DEREGISTERED to RM-REGISTERED occurs through the Registration procedure, the UE has to enter the CM-CONNECTED state.

Also, the RM is managed per access. Therefore, the UE may be RM-REGISTERED for one access, RM-DEREGISTERED for the other access, and RM-REGISTERED or RM-DEREGISTERED for two accesses.

Support of UE Connected Over Both 3GPP and Non 3GPP Access

The AMF manages two CM states for the UE: a CM state for 3GPP access and a CM state for Non 3GPP access. A maximum of one N2 interface may serve the UE for 3GPP access and a maximum of one N2 interface may serve the UE for Non-3GPP access. The UE may be in any combination of the CM states between 3GPP and Non 3GPP access, e.g., the UE may be CM-IDLE for one access and CM-CONNECTED for the other access, or may be CM-IDLE for both accesses or CM-CONNECTED for both accesses.

In respect of a non-3GPP access specific aspect, for a UE that is registered through non-3GPP access, a change point of attachment (e.g., change of WLAN AP) should not lead the UE to perform a registration update procedure. In case of Untrusted Non-3GPP access to 5G Core, the release of the Nwu signaling connection between the UE and the N3IWF is interpreted i) by the UE as criteria to go to CM-IDLE state for the Non-3GPP access and ii) by the N3IWF as criteria to release the N2 connection.

In case of Untrusted Non-3GPP access to the 5G Core, when the AMF releases the N2 interface, the N3IWF should release all the resources related with the UE including the NWu connection with the UE. When the N2 signaling connection is released, the UE state in the AMF for the non-3GPP access is CM-IDLE. The UE cannot be paged on non-3GPP access.

According to RM and CM methods for non-3GPP access, if the UE is registered with the 5G core network through non-3GPP access, the UE is RM-REGISTERED state. Afterwards, if the connection between the UE and the N3IWF and the connection between the N3IWF and the 5G core network are released, the UE may be the CM-IDLE state. This may correspond to the state that the UE registered with the 5G core network through 3GPP access may be the CM-IDLE state if the connection between the UE and the RAN and the connection between the RAN and the 5G core network are released. For reference, Deregistration procedure for untrusted non-3gpp access is defined in clause 4.12.3 of TS 23.502v0.1.1, wherein there is open issue whether the N3IWF may initiate deregistration to the AMF if IKEv2 tunnel (i.e., NWu connection) with the UE is released.

In this regard, according to the 3GPP S2-171552, the release of the NWu connection is defined that the UE becomes the CM-IDLE state instead of deregistration. That is, if the NWu connection between the UE and the N3IWF is released, the UE is shifted to the CM-IDLE state. If the UE is deregistered in a state that NWu connection is released on non-3GPP access, contexts of PDU session are all released. Instead, context for PDU session is maintained due to the CM-IDLE state of the UE. Afterwards, if the UE again configures NWu connection with the N3IWF, it is advantageous that the PDU session maintained in the 5G core network may be used as it is without being newly formed.

However, if the UE is maintained at the CM-IDLE state, a problem related to paging may occur. In more detail, the UE cannot receive paging through non-3GPP access in the CM-IDLE state of non-3GPP access as compared with that the UE may receive paging through 3GPP access during the CM-IDLE state of 3GPP access. This is because that there is no concept such as idle mode typically in non-3GPP access such as WLAN unlink 3GPP access (GERAN, UTRAN, E-UTRAN, New Radio, etc.) for defining UE operation in an idle mode. If the UE is simultaneously connected to the 5G core network through 3GPP access and non-3GPP access, and if downlink traffic is arrived in the 5G core network toward non-3GPP access, the UE may be paged through 3GPP access (see S2-170794 5.5.y Connection Management).

However, an operation how to process downlink traffic toward non-3GPP access, particularly an operation how to deliver downlink traffic for a PDU session formed through non-3GPP access to the UE if non-3GPP access is CM-IDLE has not been suggested or defined in detail.

Particularly, the UE connected to the 5G core network through non-3GPP access may be operated in various scenarios. One of the scenarios is the case that PLMN to which 3GPP access belongs is different from PLMN to which non-3GPP access belongs when the UE is registered with the 5G core network through 3GPP access and non-3GPP access. This is the case that 3GPP access belongs to VPLMN1 and non-3GPP access belongs to HPLMN to VPLMN2 as shown in FIG. 8(c). In this case, the UE is served by different AMFs for two accesses.

If non-3GPP access such as WLAN access is used in MO (Mobile Originating) only, since downlink traffic toward non-3GPP access does not exist, a method for processing downlink traffic when non-3GPP access is the CM-IDLE state may not be important. However, since voice/video service through WLAN has been recently used with a large increase, downlink traffic toward non-3GPP access cannot be disregarded. The voice/video service may be a service provided through IMS or not. Therefore, the present invention suggests a method for efficiently processing downlink traffic for non-3GPP access.

### Embodiment

Hereinafter, in various embodiments of the present invention, methods how to process downlink traffic toward non-3GPP access, particularly methods how to deliver downlink traffic for a PDU session formed through non-3GPP access to the UE if non-3GPP access is CM-IDLE will be described below. The PDU session formed through the non-3GPP access may mean a PDU session related with non-3GPP access, and is applied to the present invention.

The following descriptions are applicable to various cases of the followings (1) and (2). For example, the following descriptions may be applied to the case of (1), or may be applied to (1) and (1-1). In reference levels (e.g., (1-1) and (1-2)) of the same grade, the corresponding case is optionally applied, and a low level satisfies its high level(s). (For example, (1-1-1) satisfies cases of (1) and (1-1). (1-2-2) satisfies cases of (1) and (1-2).)

(1) The case that the UE is registered with the 5G core network through 3GPP access as well as non-3GPP access.

(1-1) The case that PLMN to which 3GPP access belongs is the same as PLMN (this may mean PLMN to which N3IWF belongs) to which non-3GPP access belongs. In this case, the UE is served by the same AMF with respect to two accesses.

(1-1-1) The case that 3GPP access is CM-IDLE when downlink traffic toward Non-3GPP access is arrived in UPF.

(1-1-2) The case that 3GPP access is CM-CONNECTED when downlink traffic toward Non-3GPP access is arrived in UPF.

(1-2) The case that PLMN to which 3GPP access belongs is different from PLMN (this may mean PLMN to which N3IWF belongs) to which non-3GPP access belongs. In this case, the UE is served by different AMFs from each other with respect to two accesses.

(1-2-1) The case that 3GPP access is CM-IDLLE when downlink traffic toward Non-3GPP access is arrived in UPF.

(1-2-2) The case that 3GPP access is CM-CONNECTED when downlink traffic toward Non-3GPP access is arrived in UPF.

(2) The case that the UE is registered with the 5G core network through non-3GPP access only.

The time when downlink traffic toward non-3GPP access in (1-1-1) and (1-1-2) is arrived in the UPF may include the time when paging is requested from the UPF to the SMF and from the SMF to the AMF or DL traffic arrival is notified, that is, the time when paging is requested to the AMF or DL traffic arrival notification is received.

The time when downlink traffic toward non-3GPP access in (1-2-1) and (1-2-2) is arrived in the UPF may include the time when paging is requested from the UPF to the SMF and from the SMF to the AMF (which manages non-3GPP access with respect to the UE) and this AMF requests AMF, which manages 3GPP access, of paging, or DL traffic arrival is notified, that is, the time when paging is requested to the latter AMF or DL traffic arrival notification is received. For reference, the operation that the AMF which manages non-3GPP access with respect to the UE requests the AMF which manages 3GPP access or DL traffic arrival is notified is suggested in the present invention as follows.

The UE (User Equipment) according to one embodiment of the present invention may receive a NAS notification message or a paging message and transmit a service request message in response to the NAS Notification message or the paging message. In this case, the serving request may include PDU session information related with non-3GPP access, and the UE may receive downlink data related with non-3GPP (or ‘associated with non-3GPP access’, hereinafter, applied equally) through 3GPP access through PDU session which related with the PDU session information and is activated in the 3GPP access. Alternatively, the service request of the UE may correspond to at least one of the case that the UE desires to receive downlink data (or service) through 3GPP access, the case that the UE desires to activate the PDU session for 3GPP access, the case that the UE desires to request service (initiation) through 3GPP access, and the case that the UE desires to respond to paging or service notification through 3GPP access.

In the aforementioned description, the NAS Notification message or the paging message may be intended for downlink data related with non-3GPP access. That is, the network transmits the NAS Notification message or the paging message for downlink data related with non-3GPP access to the UE, and the UE receives downlink data related with non-3GPP access through 3GPP access by transmitting PDU Session ID to be activated to the network through 3GPP access.

The PDU session information may be PDU session ID which may be PDU session to be activated by the UE.

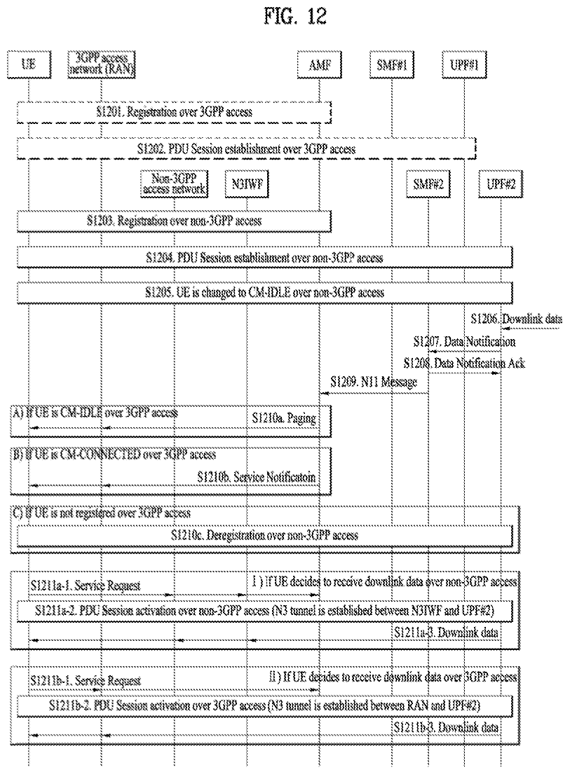

In order that the UE may receive downlink data related with non-3GPP through 3GPP access through PDU session corresponding to PDU session information, the AMF performs an operation for activating the PDU session through 3GPP access to transmit downlink data to 3GPP access. This means an operation for forming N3 tunnel (user plane) between UPF#2 and RAN referring to FIG. 12. Also, this may include an operation for forming a user plane between the UE and the network.

The UE may be CONNECTED in 3GPP access and IDLE in non-3GPP access. That is, the UE may be registered with both of 3GPP access and non-3GPP access. 3GPP access and non-3GPP access may be the same PLMN. If these conditions are satisfied, the NAS Notification message may be transmitted through 3GPP access. The NAS Notification message transmitted from the AMF may include access associated information (or RAT type information). This access associated information may be information indicating an access for which downlink data is headed, that is, an access through a PDU session is formed. For example, the access associated information may be “non-3GPP access”, “untrusted non-3GPP access”, etc., and may be represented in various formats. For example, if a value is 0, it may indicate “3GPP access”, and if the value is 1, it may indicate “non-3GPP access”. Alternatively, since Information Element (IE) indicates non-3GPP access, if the value is set to 1, it may indicate “non-3GPP access”. That is, the AMF transmits NAS message indicating that downlink data for PDU session formed through non-3GPP access has been received. The NAS message is transmitted through 3GPP access, that is, RAN. The NAS message may be a Service Notification message, for example, or may be various message names (e.g., Data Notification). Also, the NAS message of the related art may be used extensively, or may be defined newly for the present invention.

Also, the UE may be IDLE for both of 3GPP access and non-3GPP access. If this condition is satisfied, the paging message may be transmitted through 3GPP access. The UE may be registered with both of 3GPP access and non-3GPP access, and 3GPP access and non-3GPP access may be the same PLMN. That is, the AMF pages the UE through 3GPP access. Therefore, the UE transmits the paging message to the RAN, and the RAN pages the UE. The paging message may include access associated information (or RAT type information). This access associated information is the same as that included in the NAS information message.

Alternatively, if the UE is registered with non-3GPP access only and is idle in non-3GPP access, information indicating that the UE is unreachable may be transmitted from the AMF (Access and Mobility Management Function) to the SMF. After the information indicating that the UE is unreachable is delivered from the SMF to the UPF, downlink data related with non-3GPP may be deleted by the UPF. That is, the AMF may transmit, to SMF#2, a message indicating that the UE is not available or the UE is unreachable or the UE cannot be paged. This message may be transmitted to UPF#2 through the SMF#2 as it is, or in a modified/processed type, whereby the UPF#2 deletes downlink data stored therein.

Hereinafter, a method for processing downlink traffic headed for non-3GPP access will be described in view of each network node with reference to FIG. 12. In FIG. 12, a response message to each message or ACK message may be omitted. This follows a procedure of TS 23.502 or conventional understanding. A portion of the following description, which is related to aforementioned description, may be applied together with the aforementioned description within the range that is not conflict with the aforementioned description.

Referring to FIG. 12, in step S1201, the UE performs registration through 3GPP access. The Registration procedure follows clause 4.2.2 (Registration procedures) of TS 23.50.

In step S1202, the UE forms a PDU session through 3GPP access. At this time, SMF#1 and UPF#1 involve in the formed PDU session by the SMF and the UPF, respectively. One or more PDU sessions may be formed. The PDU session establishment procedure follows clause 4.3.2 of TS 23.502 (PDU Session establishment).

In step S1203, the UE performs registration through non-3GPP access. The registration procedure follows clause 4.12.2 of TS 23.502 (Registration via Untrusted non-3GPP Access).

In step S1204, the UE forms a PDU session through non-3GPP access. At this time, SMF#2 and UPF#2 involve in the formed PDU session by the SMF and the UPF, respectively. The PDU sessions may be handover from the 3GPP access, or may be formed newly from non-3GPP access. The PDU session establishment procedure follows clause 4.12.4 of TS 23.502 (UE requested PDU Session Establishment via Untrusted non-3GPP Access).

In step S1205, the UE is shifted to the CM-IDLE state with respect to non-3GPP access. This may be interpreted as NWu connection release between the UE and the N3IWF, N2 connection release between the N3IWF and the AMF, N3 tunnel release between the N3IWF and the UPF#2.

In step S1206, downlink data for a PDU session formed through Non-3GPP access is received by the UPF#2.

In step S1207, the UPF#2 buffers the received downlink data, and transmits a Data Notification message to the SMF#2. This is to notify a control plane function that there is no N3 tunnel for transmitting downlink data to the UE (or this is to request a control plane function to generate N3 tunnel or page the UE). The Data Notification message includes PDU session ID. The Data Notification message may include access associated information (or RAT type information). In this case, the access associated information may be “non-3GPP access”, “untrusted non-3GPP access”, etc.

In step S1208, the SMF#2 transmits Data Notification Ack message to the UPF#2.

In step S1209, the SMF#2 which has received the message of the step S1207 from the UPF#2 transmits N11 Message to the AMF. The N11 Message includes ID of the UE and PDU session ID. The N11 Message may include access related information (or RAT type information). In this case, the access related information may be “non-3GPP access”, “untrusted non-3GPP access”, etc.

Details of the steps S1207 to S1209 follow clause 4.2.3.3 of TS 23.502 (Network triggered Service Request). Also, the steps S1201 and S1202 may not be performed. In this case, the UE may be registered with/attached to the 5G core network through non-3GPP access only. Also, after being registered with/attached to the 5G core network through non-3GPP access, the UE may be registered with/attached to the 5G core network through 3GPP access.

Subsequently, the AMF which has received N11 Message from the SMF#2 recognizes that downlink data toward non-3GPP access has been received. As described above, information that may recognize that access for which the downlink data is headed is non-3GPP access may be one or more of PDU session ID, access associated information, information of SMF which has transmitted N11 Message. This information may be included in N11 Message, or may be information stored by the AMF. Since the AMF may know access through which the PDU session is formed (in the steps S1202 and S1204), the AMF may know access through which PDU session is formed and downlink data of the PDU session has been received even though the access associated information is not included in the N11 message.

Alternatively, the AMF may perform the same operation regardless of access through which the PDU session has been formed. In this case, if the AMF receives the N11 Message from the SMF#2, it may not be required to recognize access for which downlink data is headed.

Hereinafter, the operation of network nodes will be described in association with (or independently from) the aforementioned description, as to whether registration of each access has been performed, in accordance with conditions such as states (IDLE/connected) of the UE if each condition is satisfied.

If the UE is registered with 3GPP access and is CM-IDLE with respect to 3GPP access (condition A), the UE performs step S1210a. In step S1210a, the AMF pages the UE through 3GPP access. Therefore, the AMF transmits a paging message to the RAN, and the RAN pages the UE. The AMF may include one or more of the followings i) to iii) in the paging message.

i) Access associated information (or RAT type information): This may be information on access for which the downlink data is headed, that is, information on access through which PDU session is formed. For example, the information may be “non-3GPP access”, “untrusted non-3GPP access”, etc., and may be represented in various formats. For example, if a value is 0, it may indicate “3GPP access”, and if the value is 1, it may indicate “non-3GPP access”. Alternatively, since Information Element (IE) indicates non-3GPP access, if the value is set to 1, it may indicate “non-3GPP access”.

ii) Access associated information (or RAT type information) responding to/to be responded to paging by means of the UE: This may be access information used/to be used by the UE to respond to paging. This may use an expression method in the format described in i). Also, priority may be given to this information and thus two or more of this information may be provided instead of being provided by one access.

iii) Downlink data associated service type information: voice, video, etc.

The AMF may unconditionally page the UE through 3GPP access for downlink data toward non-3GPP access, or may page the UE on the basis of local policy, local configuration, subscriber information, explicit request from the SMF, policy information related with PDU session, property of downlink data (service type, priority, etc.), location information of the UE, etc.

The information i) and ii) included in the paging message by the AMF is also included in the paging message transmitted from the RAN to the UE. The AMF may page the UE without including the above information. This means that the AMF may perform paging without a difference from paging corresponding to the PDU session formed by downlink data toward the UE through 3GPP access. This may mean that the paging message configured by the AMF is configured equally regardless of access for which downlink data is headed.

If the UE is registered with 3GPP access and is CM-CONNECTED with respect to 3GPP access (condition B), the UE performs step S1210b.

In step S1210b, the AMF transmits, to the UE, NAS message indicating that downlink data for PDU session formed through non-3GPP access has been received. The NAS message is transmitted through 3GPP access, that is, RAN. The NAS message may be Service Notification message, for example, and may be various message names (e.g., Data Notification). Also, the NAS message of the related art may be used extensively, or may be defined newly for the present invention.

The NAS message may include one or more of the followings i) to v).

i) PDU session ID: This is ID of PDU session for downlink data.

ii) Access associated information (or RAT type information): this follows i) described in the step S1210a.

iii) Access associated information (or RAT type information) responding to/to be responded to service notification by means of the UE: This may be access information used/to be used by the UE to respond to service notification. This may use an expression method in the format described in i) of the step S1210a. Also, priority may be given to this information and thus two or more of this information may be provided instead of being provided by one access.

iv) Downlink data associated service type information: voice, video, etc.

v) All or some of information included in the paging message (used in the EPS or 5GS) of the related art may be included. For example, all or some of the information may include priority information, etc.

The AMF may unconditionally perform service notification to the UE through 3GPP access for downlink data toward non-3GPP access, or may perform service notification to the UE on the basis of local policy, local configuration, subscriber information, explicit request from the SMF, policy information related with PDU session, property of downlink data (service type, priority, etc.), location information of the UE, etc.

Although the UE is registered with 3GPP access and is CM-CONNECTED with respect to 3GPP access, if the UE is RRC-INACTIVE, the AMF may determine not to perform the step S1210b. The AMF may know that the UE is CM-CONNECTED but RRC-INACTIVE not RRC-CONNECTED, on the basis of information received from the RAN. This is because that the RAN notifies the AMF that the UE is RRC-INACTIVE. Alternatively, before the AMF transmits the service notification message to the RAN, the AMF may identify whether the UE is RRC-INACTIVE through the RAN and then may determine not to perform the step S1210b because the UE is RRC-INACTIVE.

Alternatively, since the UE is registered with 3GPP access and is CM-CONNECTED with respect to 3GPP access, the step S1210b is performed. However, since the UE is RRC-INACTIVE, when RAN receives the service notification message desired by the AMF to be transmitted to the UE, the RAN may transmit a message for rejecting the service notification message to the AMF. This is because that the RAN does not desire to perform RAN paging to transmit the service notification message to the UE. If the rejection message is received, the AMF may perform the details described in respect of the following condition C.

Although not shown in FIG. 12, if the UE is registered with 3GPP access and is CM-CONNECTED with respect to 3GPP access (condition B), instead of performing the step S1210b, the AMF may transmit downlink data to the UE through 3GPP access by forming N3 tunnel between UPF#2 and the RAN, that is, activating the PDU session. This may include an operation for forming a user plane (or DRB) between the UE and the RAN. The operation for activating the PDU session may follow an associated procedure of TS 23.502. The AMF may unconditionally transmit downlink data toward non-3GPP access to the UE through 3GPP access, or may transmit the downlink data on the basis of local policy, local configuration, subscriber information, explicit request from the SMF, policy information related with PDU session, property of downlink data (service type, priority, etc.), location information of the UE, etc. As the UPF#2 forms N3 tunnel with the RAN, the SMF may be required to be changed to another SMF. After the user plane is formed by 3GPP access, downlink data may be transmitted from the UPF#2 to the RAN and to the UE as shown in the step S1211-b.

If the UE is not registered through 3GPP access (condition C), the UE performs step S1210c. In step S1210c, the AMF performs a procedure for deregistration of the UE. This procedure may be understood with reference to clause 4.12.3 (Deregistration procedure) of TS 23.502v0.1.1 and AMF-initiated de-registration procedure of 3GPP S2-170768. At this time, steps required for the present invention and steps suitable for non-3GPP access may be applied. Also, these steps may be applied in combination. As described above, instead of performing deregistration for the UE in non-3GPP access, the AMF may transmit, to SMF#2, a message indicating that the UE is not available or the UE is unreachable or the UE cannot be paged. This message may be transmitted to UPF#2 through the SMF#2 as it is, or in a modified/processed type, whereby the UPF#2 deletes downlink data stored therein.

Hereinafter, the operation of the network nodes performed after operation related to each case of the condition A, the condition B and the condition B′ will be described.

If the UE desires to receive downlink data (or service) through non-3GPP access, steps S1211a-1˜11a-3 are performed.

The case that the UE may desire to receive downlink data (or service) through non-3GPP access may be interpreted that the case that the UE desires to activate the PDU session for non-3GPP access, the case that the UE desires to request service (initiation) through non-3GPP access, or the case that the UE desires to respond to paging or service notification through non-3GPP access.

When the UE desires to receive downlink data (or service) through non-3GPP access, one or more information of the followings i) to v) may be used.

i) Information included in the paging message when the paging message is received from the network. For example, information described in the condition A is included in this information.

ii) Information included in the service notification message when the service notification message is received from the network. For example, information described in the condition B is included in this information.

iii) Traffic steering policy/rule: this may be access associated policy for the PDU session, or may be access associated policy for downlink data related service/flow. For example, non-3GPP access may be preferred or non-3GPP access should be used.

iv) Local operating information of the UE: This may be various types of information such as available or unavailable non-3GPP access (available), signal strength of non-3GPP access (which satisfies strength of a certain level), search for N3IWF (search), and congestion of 3GPP access.

v) Access of downlink data received by the UE: If the condition B′ is performed, downlink data is transmitted through 3GPP access, and the UE recognizes that the downlink data is data for the PDU session formed through non-3GPP access. Since this recognition marks that the corresponding PDU session is formed through non-3GPP access, or a destination IP address indicated by the downlink data is IP address of the PDU session formed by the UE through non-3GPP access, or filter/steering/routing information of the downlink data is designated by non-3GPP access, the UE may regard data transmission through 3GPP access is implicit paging or paging for non-3GPP access.

In step S1211a-1, the UE requests the network of a service through non-3GPP access. The service request may include PDU session ID to be activated.

The service request of the UE may be interpreted that the UE desires to receive downlink data (or service) through non-3GPP access, the UE desires to activate the PDU session for non-3GPP access, the UE desires to request service (initiation) through non-3GPP access, or the UE desires to respond to paging or service notification through non-3GPP access.

Although FIG. 12 simply illustrates that the UE transmits a service request message to the AMF through the N3IWF through non-3GPP access, this accompanies a) access of the UE to non-3GPP access network, and b) an operation for forming IKEv2/IPSec tunnel with the N3IWF. The service request message delivered to the final AMF may be transmitted from the UE to the network as a part of the procedures a) and b). The Service Request message may be in the form of NAS message or parameter, or may be a registration type value (e.g., “registration for service request” or “registration for connection”) indicating the service request information. If the UE does not transmit the service request message in the form of NAS message, the N3IWF may generate/process N2 message on the basis of information (parameter, etc.) provided by the UE and then transmit the N2 message to the AMF.

In step S1211a-2, the AMF performs an operation for activating the PDU session through non-3GPP access to transmit downlink data to the non-3GPP access. This finally means an operation for forming N3 tunnel (user plane) between the UPF#2 and the N3IWF. Also, this may include an operation for forming a user plane between the UE and the network. This procedure of forming the user plane may be understood with reference to a related procedure of TS 23.502.

If the condition B′ is performed and N3 tunnel is already formed between the UPF#2 and the RAN, a changing procedure of forming N3 tunnel between the UPF#2 and the N3IWF should be performed. This procedure may accompany an operation for releasing the user plane formed between the RAN and the UE when the condition B′ is performed. The procedure may be initiated when the procedure is explicitly requested by the UE in step S1211a-1. Alternatively, the AMF or the SMF#2, which manages the UPF#2, may initiate the procedure even though the procedure is explicitly requested by the UE. As this procedure, the procedure (some necessary same or similar steps) of performing handover of the PDU session from 3GPP access to non-3GPP access may be used. Basically, after the user plane is completely formed by non-3GPP access, the user plane toward 3GPP access may be released to avoid data loss. To this end, if it is recognized that a data flow from the UPF#2 to 3GPP access is not generated any more (to this end, data inactivity timer may be used), the user plane toward 3GPP access may be released.

In step S1211a-3, the downlink data is transmitted to the UE through N3IWF and non-3GPP access.

If the UE desires to receive downlink data (or service) through 3GPP access, steps S1211b-1 to 11b-3 are performed.

When the UE desires to receive downlink data (or service) through 3GPP access, one or more information of the followings may be used.

i) Information included in the paging message when the paging message is received from the network. For example, information described in the condition A is included in this information.

ii) Information included in the service notification message when the service notification message is received from the network. For example, information described in the condition B is included in this information.

iii) Traffic steering policy/rule: this may be access associated policy for the PDU session, or may be access associated policy for downlink data related service/flow. For example, 3GPP access may be preferred or 3GPP access should be used.

iv) Local operating information of the UE: This may be various types of information such as available or unavailable non-3GPP access (unavailable), signal strength of non-3GPP access (which does not satisfy strength of a certain level), search for N3IWF (it is not searched), and congestion of 3GPP access.

In step S1211b-1, the UE requests the network of a service through 3GPP access. The service request may include PDU session ID to be activated.

The service request of the UE may be interpreted that the UE desires to receive downlink data (or service) through 3GPP access, the UE desires to activate the PDU session for 3GPP access, the UE desires to request service (initiation) through 3GPP access, or the UE desires to respond to paging or service notification through 3GPP access.

Also, the NAS message of the related art may be used as the service request message as it is or extensively, or a message defined newly may be used as the service request message.

In step S1211b-2, the AMF performs an operation for activating the PDU session through 3GPP access to transmit downlink data to the 3GPP access. This finally means an operation for forming N3 tunnel (user plane) between the UPF#2 and the RAN. Also, this may include an operation for forming a user plane between the UE and the network. This procedure of forming the user plane may be understood with reference to a related procedure of TS 23.502. As the UPF#2 forms N3 tunnel with the RAN, the SMF may be required to be changed to another SMF.

In step S1211b-3, downlink data is transmitted to the UE through 3GPP access. The UE may determine/recognize to internally use 3GPP access to receive downlink data (or service) through 3GPP access instead of performing the steps S1211b-1 to 1211b-3. If the B′ is performed, the downlink data is transmitted through 3GPP access. The UE recognizes that the downlink data is data for PDU session. Since this recognition marks that the corresponding PDU session is formed through non-3GPP access, or a destination IP address indicated by the downlink data is IP address of the PDU session formed by the UE through non-3GPP access, or filter/steering/routing information of the downlink data is designated by non-3GPP access, the UE may determine/recognize that the PDU session is served by 3GPP access without performing the steps S1211b-1 to S1211b-3. For this reason, access for the PDU session may be managed by being changed to 3GPP access. Also, uplink traffic for the PDU session may be transmitted through 3GPP access.

Even though the UE desires to receive downlink data through non-3GPP access, the UE may transmit a message for notifying/requesting that the UE desires to receive downlink data through non-3GPP access. In this case, the message may include information indicating that the UE desires to receive downlink data through non-3GPP access. Afterwards, the UE may activate the PDU session and the network through non-3GPP access, whereby the UE may receive downlink data through non-3GPP access.

In FIG. 12, after the AMF receives N11 message from the SMF#2 through step S1209, if the AMF does not manage RM state for 3GPP access of the UE, the condition C may be performed but the followings may be performed.

i) The AMF transmits, to the UDM, a message indicating downlink data toward non-3GPP access has been received. This message may include ID information of the UE and PDU session ID.

ii) If the UDM recognizes that the UE has been registered with 3GPP access (in this case, since there is serving AMF information on 3GPP access with respect to the UE, this will be referred to as AMF#2), the UDM transmits, to the AMF#2, a message indicating that the downlink data toward non-3GPP access has been received with respect to the UE on the basis of the information received from the AMF. Afterwards, the AMF#2 performs A) or B) of FIG. 12 on the basis of CM state of the UE and then performs an operation subsequent to the aforementioned operation. Therefore, in the aforementioned operation, although one AMF serves 3GPP access and non-3GPP access, AMF#2 and AMF should be interpreted by substitution. If the two AMFs should perform interaction, the AMFs may perform interaction through the UDM.

iii) If the UDM recognizes that the UE has not been registered with 3GPP access, the UDM transmits, to the AMF, a message indicating that the UE has not been registered with 3GPP access or a message for rejecting the above case i).

Afterwards, the AMF performs the operation described in the condition C.

Instead of unconditionally transmitting, to the UDM, the message indicating that the downlink data toward non-3GPP access has been received, as described in the above case i), the AMF may identify whether the UE has been registered with 3GPP by transmitting, to the UDM, a query message for querying whether the UE has been registered with 3GPP. If the UE has been registered with 3GPP, the AMF performs i) and then performs ii). If the UE is not registered with 3GPP, the AMF performs the operation described in the condition C.

In the related art, if a voice call should be received from the CS, the UE performs an operation for changing RAT, that is, an operation for changing E-UTRAN to GERAN or UTRAN. That is, the UE should unconditionally change the current access to access that enables CS service without selecting an access (RAT) which should receive a downlink service. This means that connection/attachment of access of the related art—this is an access for receiving a notification message (paging message or CS service notification message) for the downlink service reception in the UE—is released and connection/attachment to another access should be made.

On the contrary, the present invention suggests an operation for allowing a UE to additionally connect/attach to another access (non-3GPP access) to receive downlink data while maintaining connection/attachment to access of the related art (5G-RAN)—this is an access for receiving a notification message (paging message or service notification message) for the downlink data reception in the UE. Alternatively, the present invention suggests an operation for allowing a UE to receive downlink data through the access of the related art without additional connection/attachment through another access (non-3GPP access) while maintaining connection/attachment to access of the related art (5G-RAN)—this is an access for receiving a notification message (paging message or service notification message) for the downlink data reception in the UE.

Also, in the present invention, the UE may select 3GPP access on the basis of its local operating information instead of determining to unconditionally receive downlink data through non-3GPP access if indicated by the network. Alternatively, on the contrary, even though the network indicates, to the UE, to receive downlink data through 3GPP access, the UE may select non-3GPP access on the basis of its local operating information.

Although the above description is based on access through which downlink data (service) is received, this may be interpreted to include uplink data (service) which uses a PDU session the same as or corresponding to downlink data (service) as well as the downlink data (service).

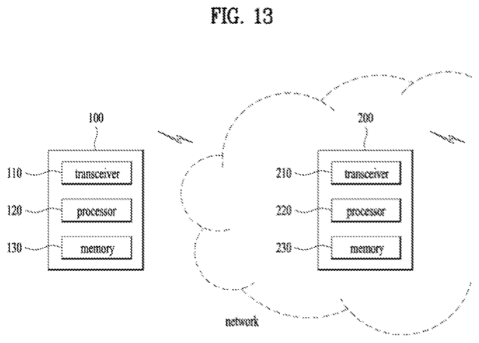

FIG. 13 is a diagram illustrating a configuration of a user equipment and a network node device according to the preferred embodiment of the present invention.

Referring to FIG. 13, a UE 100 according to the present invention may include a transceiver 110, a processor 120 and a memory 130. The transceiver 110 may be configured to transmit various signals, data and information to an external device and receive various signals, data and information from the external device. The UE 100 may be connected with the external device through the wire and/or wireless. The processor 120 may control the overall operation of the UE 100, and may be configured to perform a function of operation-processing information to be transmitted to and received from the external device. The memory 130 may store the operation-processed information for a predetermined time, and may be replaced with a buffer (not shown). Also, the processor 120 may be configured to perform a UE operation suggested in the present invention. In detail, the processor 120 receives NAS notification message or paging message, and transmits a service request in response to the NAS notification message or the paging message, wherein the service request includes PDU session information, and the UE may receive downlink data related with non-3GPP through 3GPP access through PDU session corresponding to the PDU session information.

Referring to FIG. 13, the network node device 200 according to the present invention may include a transceiver 210, a processor 220, and a memory 230. The transceiver 210 may be configured to transmit various signals, data and information to an external device and to receive various signals, data and information from the external device. The network node device 200 may be connected with the external device through the wire and/or wireless. The processor 220 may control the overall operation of the network node device 200, and may be configured to allow the network node device 200 to perform a function of operation-processing information to be transmitted to and received from the external device. The memory 230 may store the operation-processed information for a predetermined time, and may be replaced with a buffer (not shown). Also, the processor 220 may be configured to perform a network node operation suggested in the present invention.

Also, the details of the aforementioned UE 100 and the aforementioned network node device 200 may be configured in such a manner that the aforementioned various embodiments of the present invention may independently be applied to the aforementioned UE 100 and the aforementioned network node device 200, or two or more embodiments may simultaneously be applied to the aforementioned UE 100 and the aforementioned network node device 200, and repeated description will be omitted for clarification.

The aforementioned embodiments according to the present invention may be implemented by various means, for example, hardware, firmware, software, or their combination.

If the embodiments according to the present invention are implemented by hardware, the method according to the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiments according to the present invention are implemented by firmware or software, the method according to the embodiments of the present invention may be implemented by a type of a module, a procedure, or a function, which performs functions or operations described as above. A software code may be stored in a memory unit and then may be driven by a processor. The memory unit may be located inside or outside the processor to transmit and receive data to and from the processor through various means which are well known.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. It is also obvious to those skilled in the art that claims that are not explicitly cited in each other in the appended claims may be presented in combination as an embodiment of the present invention or included as a new claim by a subsequent amendment after the application is filed.

### INDUSTRIAL APPLICABILITY

Although the aforementioned various embodiments of the present invention have been described based on the 3GPP system, the aforementioned embodiments may equally be applied to various mobile communication systems.

1. A method for receiving, by a UE (User Equipment), data related with non-3GPP through 3GPP access in a wireless communication system, the method comprising the steps of:
receiving NAS notification message or a paging message message for downlink data related with the non-3GPP access; and
transmitting a service request in response to the NAS notification message or the paging message,
wherein the service request includes PDU session information related with non-3GPP access,
wherein the UE receives downlink data related with non-3GPP via a PDU session which related with the PDU session information and is activated in 3GPP access, and
wherein the UE receives the downlink data through 3GPP access,
wherein the UE is in one of two states, a first state that the UE is connected state in the 3GPP access and IDLE state in the non-3GPP access and a second state that the UE is IDLE state in both of the 3GPP access and the non-3GPP access.

2-3. (canceled)

4. The method according to claim 1, wherein the 3GPP access and the non-3GPP access belong to the same PLMN.

5. The method according to claim 4, wherein the UE is registered with both of the 3GPP access and the non-3GPP access.

6. The method according to claim 5, wherein the NAS notification message includes access associated information and is transmitted through the 3GPP access.

7. (canceled)

8. The method according to claim 1, wherein the paging message includes access associated information, and is transmitted through the 3GPP access.

9-10. (canceled)

11. The method according to claim 1, wherein, if the UE is registered with the non-3GPP access only and is IDLE state in the non-3GPP access, information indicating that the UE is unreachable is transmitted from AMF (Access and Mobility Management Function) to SMF.

12. The method according to claim 11, wherein the information indicating that UE is unreachable is delivered from the SMF to UPF.

13. The method according to claim 12, wherein the downlink data related with the non-3GPP access is deleted by the UPF after the information indicating that the UE is unreachable is delivered to the UPF.

14. The method according to claim 1, wherein the AMF of the UE stores information indicating that PDU session is for the non-3GPP access or the 3GPP access.

15. A UE device for receiving data through non-3GPP access or 3GPP access in a wireless communication system, the UE device comprising:
a transceiver; and
a processor,
wherein the processor receives NAS notification message or a paging message for downlink data related with the non-3GPP access, and transmits a service request in response to the NAS notification message or the paging message, wherein the service request includes PDU session information related with non-3GPP access, wherein the UE receives downlink data related with non-3GPP via a PDU session which related with the PDU session information and is activated in 3GPP access, and wherein the UE receives the downlink data through 3GPP access, wherein the UE is in one of two states, a first state that the UE is connected state in the 3GPP access and IDLE state in the non-3GPP access and a second state that the UE is IDLE state in both of the 3GPP access and the non-3GPP access.
